(19) United States
(12) Patent Application Publication
(10) Pub. No.: US 2019/0376593 A1
(43) Pub. Date: Dec. 12, 2019

(54) GEAR CAPABLE OF DISPLAYING ABRASION

(71) Applicant: YOUCHEN TECHNOLOGY CO., LTD., TAOYUAN CITY (TW)

(72) Inventor: Han-Long HSU, TAOYUAN CITY (TW)

(21) Appl. No.: 16/422,420

(22) Filed: May 24, 2019

(30) Foreign Application Priority Data
Jun. 8, 2018 (TW) 107119799

(51) Int. Cl. F16H 57/01

(52) U.S. Cl. CPC F16H 57/01; B33Y 80/00; F16H 2057/012

(57) ABSTRACT

A gear capable of displaying abrasion contains multiple teeth formed on the gear and at least one covering layer formed on the multiple teeth. At least one color of the at least one covering layer is different from that of the multiple teeth so that a user distinguishes whether the gear is abraded by viewing the at least one color of the at least one covering layer.

### FIELD OF THE INVENTION

The present invention relates to a gear which is capable of distinguishing whether the gear is abraded by viewing the at least one color of the at least one covering layer.

### BACKGROUND OF THE INVENTION

A variety of conventional gears are applicable for machines or watches and contain multiple teethes formed around peripheral sides of the variety of conventional gears respectively so as to mesh with other gears or mechanical parts, thus transferring torque and kinetic energy.

However, it is difficult to distinguish whether the variety of conventional gears are abraded after a period of using time.

The present invention has arisen to mitigate and/or obviate the afore-described disadvantages.

### SUMMARY OF THE INVENTION

The primary aspect of the present invention is to provide a gear which is capable of distinguishing whether the gear is abraded by viewing the at least one color of the at least one covering layer.

To obtain above-mentioned aspects, a gear provided by the present invention contains: multiple teeth formed on the gear and at least one covering layer formed on the multiple teeth. At least one color of the at least one covering layer is different from that of the multiple teeth so that a user distinguishes whether the gear is abraded by viewing the at least one color of the at least one covering layer.

Preferably, the at least one color of the at least one covering layer is different.

Preferably, the gear is any one of a straight gear, a helical gear, a herringbone gear, a gear bearing, and a worm.

Preferably, the gear is made of any one of metal, non-ferrous metal alloys, cast iron, powder metallurgy, plastic material, steel, and plastic steel.

Preferably, the at least one covering layer is injection molded on the multiple teeth of the gear.

Preferably, the at least one covering layer is formed on the multiple teeth in an electroplate manner.

### BRIEF DESCRIPTION OF THE DRAWINGS

FIG. 1 is a perspective view showing the assembly of a gear according to a preferred embodiment of the present invention.

FIG. 2 is a perspective view showing the gear being put into the mold according to the preferred embodiment of the present invention.

FIG. 3 is a perspective view showing at least one covering layer being formed on the multiple teeth of the gear according to the preferred embodiment of the present invention.

FIG. 4 is a perspective view showing the gear having the at least one covering layer being removed from the mold according to the preferred embodiment of the present invention.

FIG. 5 is a perspective view showing the operation of the gear according to the preferred embodiment of the present invention.

### DETAILED DESCRIPTION OF THE PREFERRED EMBODIMENTS

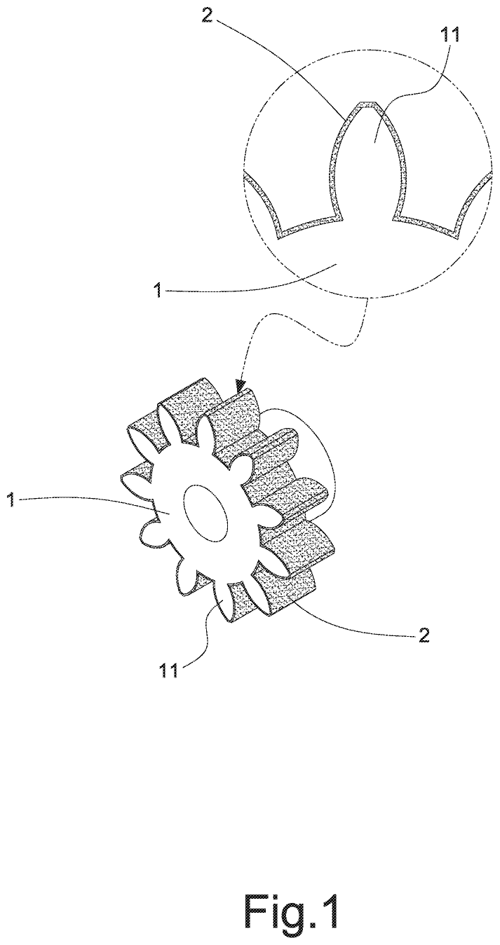

With reference to FIG. 1, a gear 1 capable of displaying abrasion according to a preferred embodiment of the present invention comprises multiple teeth 11 formed on the gear 1, at least one covering layer 2 formed on the multiple teeth 11, wherein at least one color of the at least one covering layer 2 is different from that of the multiple teeth 11. The gear 1 is any one of a straight gear, a helical gear, a herringbone gear, a gear bearing, and a worm. The gear 1 is made of any one of metal, non-ferrous metal alloys, cast iron, powder metallurgy, plastic material, steel, and plastic steel, wherein the gear 1 is made in a three-dimensional (3D) printing manner.

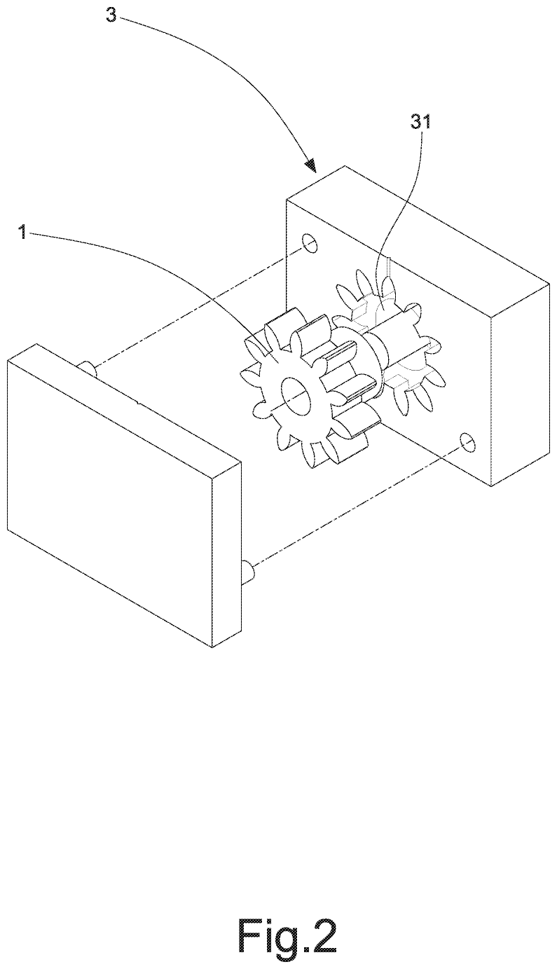

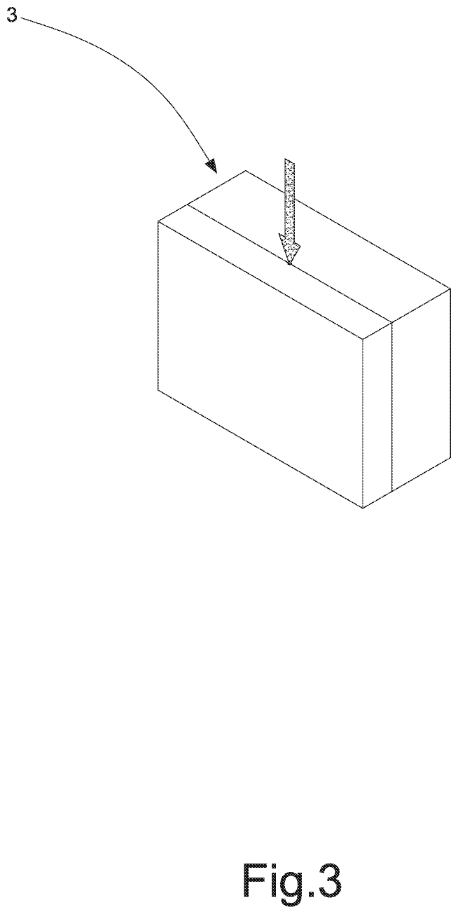

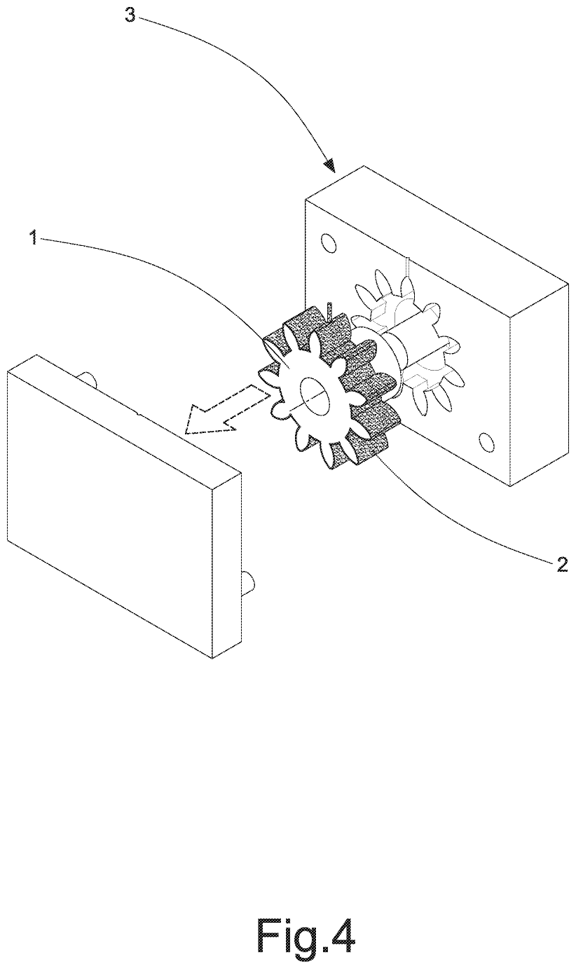

Referring to FIG. 2, a mold 3 includes a recessed portion 31, a size of which is more than the gear 1 so that after the gear 1 is put into the recessed portion 31, the plastic material is fed into a gap between the gear 1 and the recessed portion 31 so as to injection mold the at least one covering layer 2 on the multiple teeth 11 of the gear 1 (as shown in FIG. 3), and the gear 1 is removed from the mold 3 (as illustrated in FIG. 4), thus one-piece molding the at least one covering layer 2 on the multiple teeth 11 of the gear 1.

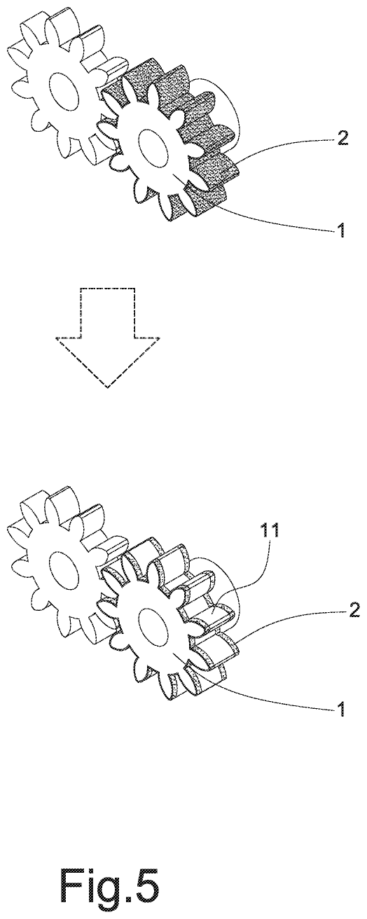

The at least one color of the at least one covering layer 2 is different from the multiple teeth 11, for example, the color of the multiple teeth 11 is white, and the at least one color of the at least one covering layer 2 is red. Referring to FIG. 5, when the gear 1 is red after a period of using time, it represents the at least one covering layer 2 is formed on the multiple teeth 11, and the gear 1 is usable. When the gear 1 is white, it represents the at least one covering layer 2 is abraded, thus replacing the gear 1.

Preferably, the at least one covering layer 2 is formed on the multiple teeth 11 in an electroplate manner

In another embodiment, a number of the at least one covering layer 2 is changeable, and the at least one color of the at least one covering layer 2 is different. For example, the number of the at least one covering layer 2 is three, wherein a color of a first covering layer 2 is green, a color of a second covering layer 2 is yellow, and a color of a third covering layer 2 is red, such that a user distinguishes whether the gear 1 is abraded after viewing the at least one color of the at least one covering layer 2 respectively.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A gear capable of displaying abrasion comprising multiple teeth formed on the gear, at least one covering layer formed on the multiple teeth, wherein at least one color of the at least one covering layer is different from that of the multiple teeth so that a user distinguishes whether the gear is abraded by viewing the at least one color of the at least one covering layer.

2. The gear as claimed in claim 1, wherein the at least one color of the at least one covering layer is different.

3. The gear as claimed in claim 1, wherein the gear is any one of a straight gear, a helical gear, a herringbone gear, a gear bearing, and a worm.

4. The gear as claimed in claim 2, wherein the gear is any one of a straight gear, a helical gear, a herringbone gear, a gear bearing, and a worm.

5. The gear as claimed in claim 1, wherein the gear is made of any one of metal, non-ferrous metal alloys, cast iron, powder metallurgy, plastic material, steel, and plastic steel.

6. The gear as claimed in claim 2, wherein the gear is made of any one of metal, non-ferrous metal alloys, cast iron, powder metallurgy, plastic material, steel, and plastic steel.

7. The gear as claimed in claim 1, wherein the at least one covering layer is injection molded on the multiple teeth of the gear.

8. The gear as claimed in claim 2, wherein the at least one covering layer is injection molded on the multiple teeth of the gear.

9. The gear as claimed in claim 1, wherein the at least one covering layer is formed on the multiple teeth in an electroplate manner.

10. The gear as claimed in claim 2, wherein the at least one covering layer is formed on the multiple teeth in an electroplate manner.
